(19) United States
(12) Patent Application Publication
(10) Pub. No.: US 2026/0366464 A1
(43) Pub. Date: Nov. 19, 2026

(54) ASSEMBLY COMPRISING AN ACCESSORY GEARBOX AND A LUBRICATION UNIT

(71) Applicant: SAFRAN AIRCRAFT ENGINES, Paris (FR)

(72) Inventors: Loic Marius Joseph ALBOUY, Moissy-Cramayel (FR); Valentin PAUTRE, Moissy-Cramayel (FR)

(21) Appl. No.: 19/146,863

(22) PCT Filed: Jan. 10, 2024
(86) PCT No.: PCT/FR2024/050023

§ 371 Date: Jul. 9, 2025

(30) Foreign Application Priority Data
Jan. 19, 2023 (FR) FR2300504

(51) Int. Cl. F02C 7/32; F02C 7/06

(52) U.S. Cl. CPC F02C 7/32; F02C 7/06; F05D 2220/323; F05D 2260/98

(57) ABSTRACT

An assembly for an aircraft turbine engine, the assembly including an accessory gearbox including first and second walls which between them define an internal cavity, and a gear train which is arranged in the internal cavity and is intended to be driven by a shaft of the turbine engine; and a lubrication unit including an oil supply pump and an oil recovery pump, the supply and recovery pumps each including at least one rotor which is driven by the gear train, the assembly wherein the rotors of the supply and recovery pumps are arranged on either side of the gear train, and in that the rotor of the supply pump is arranged in the internal cavity.

### TECHNICAL FIELD OF THE INVENTION

The invention relates to an assembly for an aircraft turbomachine, the assembly comprising an accessory gearbox and a lubrication unit.

### PRIOR ART The prior art is illustrated by the documents EP-A1-3 054 128 and US-A1-2012117982.

An aircraft turbomachine generally extends along and around a longitudinal axis. It comprises a gas generator which typically comprises, from upstream to downstream, in the direction of gas flow in the turbomachine, a fan, a low-pressure compressor, a high-pressure compressor, a gas combustion chamber, a high-pressure turbine and a low-pressure turbine.

The rotor of the low-pressure compressor is typically connected to the rotor of the low-pressure turbine by means of a low-pressure shaft. The rotor of the high-pressure compressor is connected to the rotor of the high-pressure turbine by a high-pressure shaft. The shafts are guided in rotation by guide bearings, which need to be lubricated to ensure that they operate correctly.

It is therefore known to spray lubricating oil onto the guide bearings. In order to protect the associated members of the turbomachine from this lubricating oil, the guide bearings are typically arranged in lubrication enclosures.

To ensure lubrication of the bearings in the lubrication enclosures, the turbomachine typically includes an oil circuit. The oil circuit is typically a closed circuit comprising a bearing lubrication circuit and an oil recovery circuit for the lubrication enclosures.

The oil circuit typically comprises a lubrication unit connected to an oil tank. The lubrication unit includes supply and recovery pumps. The supply pump allows oil to be drawn from the tank and distributed to the lubrication enclosures via the supply circuit, while the recovery pump allows the oil to be drawn from the lubrication enclosures and returned to the tank via the recovery circuit. The lubrication unit typically comprises a casing with oil inlets and outlets for each pump and a drive shaft for the rotors of these pumps. The drive shaft is typically guided in rotation in the casing of the lubrication unit.

In order to drive the rotors of the lubrication unit's pumps, it is common practice to mount and secure the lubrication unit on an accessory gearbox (AGB). The accessory gearbox is used to transmit mechanical power from the turbomachine to the accessories of the turbomachine, such as the pumps of the lubrication unit. The accessory gearbox typically comprises a box comprising a first wall and a second wall defining between them an internal cavity in which is arranged a gear train having a series of pinions meshing with each other. The casing of the lubrication unit is secured to one of the walls of the accessory gearbox and one end of the drive shaft of the rotors is coupled in rotation to one of the pinions of the gear train.

This configuration of the gearbox and lubrication unit is not entirely satisfactory. In fact, such an assembly has a considerable mass. It can also be difficult to integrate into the turbomachine, given the volume of such an assembly, which is incompatible with highly congested areas of the turbomachine.

The document FR-A1-2 928 696 proposes an assembly comprising an accessory gearbox comprising a box having first and second walls between which is arranged a gear train having a series of intermeshing pinions. The assembly further comprises an oil supply pump and a first drive shaft of a rotor of the supply pump, and a hydraulic pump and a second drive shaft of the rotor of the hydraulic pump. The oil supply pump is secured to the first wall and the first drive shaft is coupled in rotation with a pinion of the gear train. The hydraulic pump is secured to the second wall and the second drive shaft is coupled in rotation with the pinion of the gear train to which the first drive shaft is coupled.

Although it reduces the overall volume, this solution is not entirely satisfactory. In fact, each pump takes up a lot of space, increasing the overall volume on either side of the accessory gearbox. As a result, the overall weight is not reduced. In addition, the presence of two pumps mounted and secured to each of the walls increases the number of interfaces with the accessory gearbox, which complicates the installation of the assembly.

The document WO-A1-2021116570 proposes an assembly comprising a plate and an accessory gearbox comprising a casing with first and second walls. The plate is connected to one of the walls of the casing. The plate has means for securing various items of equipment, also known as accessories, which can be driven by the gear train of the accessory gearbox. This equipment includes, in particular, a fuel pump, and the plate also incorporates fluid inlet and outlet pipes.

Although this reduces the overall volume, there is still room for improvement. In fact, the plate remains relatively bulky and heavy considering the functions it incorporates. Also, the presence of the plate does not significantly reduce the number of interfaces with the accessory gearbox. The installation of the assembly therefore remains relatively complex.

In this context, there is a need to provide an assembly comprising an accessory gearbox and a lubrication unit comprising an oil supply pump and an oil recovery pump, which is space-saving, lightweight and easy to assemble.

### SUMMARY OF THE INVENTION

To this end, the invention proposes an assembly for an aircraft turbomachine, the assembly comprising:
an accessory gearbox comprising:
first and second walls defining between them an internal cavity, and
a gear train arranged in the internal cavity, intended to be driven by a shaft of the turbomachine, and
a lubrication unit comprising an oil supply pump and an oil recovery pump, the supply and recovery pumps each comprising at least one rotor driven by the gear train.

The assembly is remarkable in that the rotors of the supply and recovery pumps are arranged on either side of the gear train, and in that the rotor of the supply pump is arranged in the internal cavity.

According to the invention, the rotor of the supply pump is located in the internal cavity of the gearbox. In other words, the rotor of the supply pump is located in the gearbox. This eliminates the need for a bulky casing of the lubrication unit incorporating the rotor of the supply pump. The overall dimension of the lubrication unit, and therefore of the assembly, is considerably reduced.

In addition, according to the invention, the rotors of the supply and recovery pumps are arranged on either side of the gear train. This characteristic allows the load on the accessory gearbox to be balanced.

Thanks to the invention, the volume and weight of the assembly is greatly reduced without increasing the number of interfaces between the lubrication unit and the gearbox.

This simplifies the installation of the assembly.

The invention may comprise one or more of the following characteristics, taken alone or in combination with each other:
the supply pump comprises an oil inlet and an oil outlet provided on the first wall,
the first wall comprises a cylindrical body extending in a projecting manner and having a cylindrical housing opening into the internal cavity and fluidly connected to the oil inlet and outlet, the rotor of the supply pump being arranged in the cylindrical housing,
the first wall further comprises a receiving bowl of an oil filter, the receiving bowl extending into the internal cavity and being connected to the cylindrical body by an oil outlet pipe,
the recovery pump comprises a casing comprising at least one oil inlet and an internal housing wherein the rotor of the recovery pump is arranged, the casing being mounted and secured to the second wall,
the casing comprises at least one oil outlet pipe fluidly connected to an oil outlet orifice of the recovery pump, the orifice being formed on the first wall,
the gearbox further comprises an oil circulation passage in the internal cavity connecting the pipe to the orifice,
the supply pump comprises two rotors driven by the gear train and/or in that the recovery pump comprises at least two rotors driven by the gear train,
the rotor or rotors of the supply pump are driven by a first drive shaft which is coupled to the gear train, and the rotor or rotors of the recovery pump are driven by a second drive shaft which is coupled to the gear train, the first and second shafts extending respectively on either side of the gear train,
the gear train comprises a series of toothed wheels meshing together, and the first and second drive shafts are coupled in rotation to a single toothed wheel of the gear train,
the first wall and/or the second wall comprises at least one valve.

The invention also relates to a turbomachine for an aircraft comprising:
a fan configured to drive an air flow separating into a primary air flow and a secondary air flow,
a primary duct for the flow of the primary air flow,
a secondary duct for the flow of the secondary air flow,
an inter-duct compartment separating the primary duct and secondary duct.

The turbomachine is remarkable in that it also comprises an assembly according to any of the preceding characteristics and located in the inter-duct compartment.

### BRIEF DESCRIPTION OF THE FIGURES

Further characteristics and advantages will be apparent from the following description of non-limiting embodiments of the invention with reference to the accompanying drawings in which:

FIG. 1 is a longitudinal sectional view of an example of an aircraft turbomachine according to the invention;

FIG. 2 is a schematic view of an oil circuit comprising a lubrication circuit and an oil recovery circuit,

FIG. 3 is a perspective view of an assembly according to the invention comprising an accessory gearbox and a lubrication unit,

FIG. 4 is a side view of FIG. 3 in which the first wall is visible,

FIG. 5 is an enlarged view of FIG. 4 in which the first cover of the first wall has been removed,

FIG. 6 is a side view of FIG. 3 in which the second wall is visible,

FIG. 7 is another side view of FIG. 3 in which the second wall is visible,

FIG. 8 is an enlarged view of FIG. 6 in which the second wall cover has been removed,

FIG. 9 is a perspective view of a recovery pump,

FIG. 10 is an exploded perspective view of the recovery pump,

FIG. 11 is a schematic view of the assembly according to the invention.

### DETAILED DESCRIPTION OF THE INVENTION

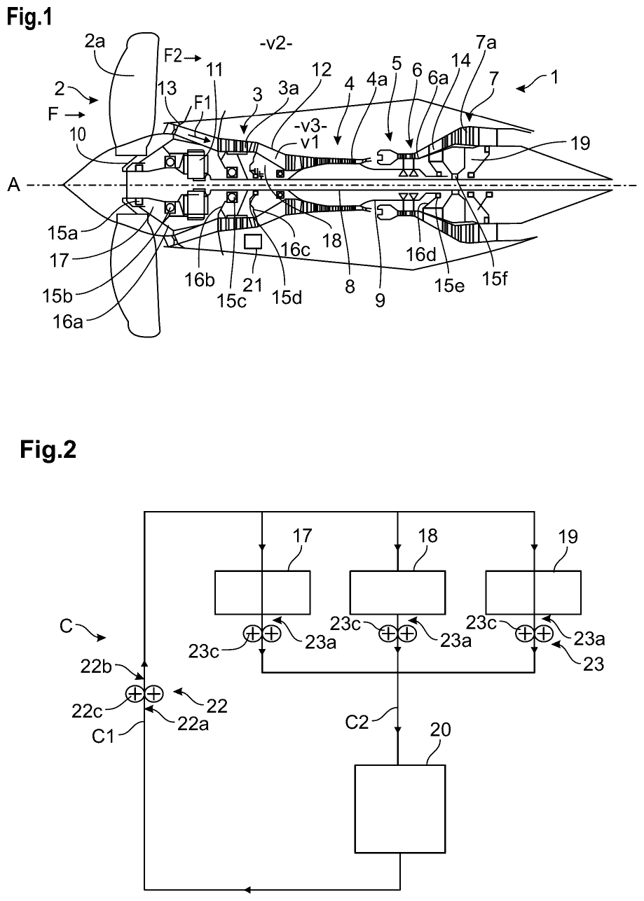

An example of an aircraft turbomachine 1 according to the invention is shown very briefly in FIG. 1. The turbomachine 1 is, for example, a turboprop engine.

The turbomachine 1 extends along a longitudinal axis A. An air flow F flows through the turbomachine 1.

For the purposes of the present invention, the terms “upstream” and “downstream” are understood in relation to the direction of flow of the air flow F in the turbomachine 1 along the longitudinal axis A.

Furthermore, the terms “longitudinal” and “longitudinally” refer to the longitudinal axis A of the turbomachine 1. The terms “radial” and “radially” refer to a radial axis perpendicular to the longitudinal axis A. The terms “outside” and “inside” are understood in relation to the distance from the longitudinal axis A along the radial axis perpendicular to the longitudinal axis A.

The turbomachine 1 comprises, from upstream to downstream, a fan 2, a low-pressure compressor 3, a high-pressure compressor 4, a combustion chamber 5, a high-pressure turbine 6 and a low-pressure turbine 7.

Each compressor 3, 4 comprises a compressor rotor 3a, 4a and each turbine 6, 7 comprises a turbine rotor 6a, 7a. The compressor 3a, 4a and turbine rotors 6a, 7a are made up of a plurality of stages, each comprising a bladed wheel.

The compressor rotor 3a of the low-pressure compressor 3 is connected to the turbine rotor 7a of the low-pressure turbine 7 by a low-pressure shaft 8. They form a low-pressure body.

The compressor rotor 4a of the high-pressure compressor 4 is connected to the turbine rotor 6a of the high-pressure turbine 6 by a high-pressure shaft 9. They form a high-pressure body.

The low-pressure 8 and high-pressure 9 shafts are centred on the longitudinal axis A and mobile in rotation about the longitudinal axis A. The high-pressure shaft 9 is arranged coaxially around the low-pressure shaft 8.

The air flow F passes through the fan 2 and divides into a primary air flow F1 passing through a primary duct v1 and a secondary air flow F2 passing through a secondary duct v2 surrounding the primary duct. The primary air flow F1 passes through the low-pressure 3 and the high-pressure 4 compressors. The compressed primary air flow F1 then passes through the combustion chamber 5, where it is mixed with a fuel. The gases produced by combustion pass through the high-pressure turbine 6 and the low-pressure turbine 7. The energy in the gases is converted by the turbine rotor 7a of the low-pressure turbine 7 into mechanical energy allowing to drive in rotation the low-pressure shaft 8 and consequently the low-pressure compressor 3. The fan 2 comprises a disc that can rotate about the longitudinal axis A and vanes 2a evenly distributed over the disc. The fan 2, for example, is of the non-ducted type. In contrast to a ducted fan 2, the fan 2 does not comprise a fan casing surrounding the vanes 2a. In another example, not shown, the fan 2 is of the ducted type.

The disc is driven in rotation by a fan shaft 10. Advantageously, the fan shaft 10 is connected to the low-pressure shaft 8, for example via a speed reduction gear 11. The speed reduction gear 11 is of mechanical type. For example, it may have an epicyclic or planetary train gear. Not illustrated, the speed reduction gear 11 typically comprises a sun gear and a ring gear centred on the longitudinal axis A. It also comprises planet gears meshing with the sun gear and the ring gear. It also includes a planet carrier.

The sun gear is secured in rotation to the low-pressure shaft 8 and forms the input of the speed reduction gear 11, while one or other of the ring gear and the planet carrier, depending on the configuration of the speed reduction gear 11, is secured in rotation to the fan shaft 10 and forms the output of the speed reduction gear 11.

The speed reduction gear 11 allows the fan shaft 10 to be driven at a lower speed than the speed of rotation of the low-pressure shaft 8. This allows to increase the bypass ratio of the turbomachine 1.

The turbomachine 1 also includes an inter-compressor casing 12 arranged axially between the low-pressure compressor 3 and the high-pressure compressor 4. The inter-compressor casing 12 comprises, for example, an internal shell and an external shell which are centred on the longitudinal axis A. The internal and external shells are connected by arms, for example.

The turbomachine 1 may also comprise an inlet casing 13. The inlet casing 13 is arranged axially between the fan 2 and the low-pressure compressor 3. The inlet casing 13 comprises, for example, an internal shell and an external shell which are centred on the longitudinal axis A. The internal and external shells are connected by arms, for example.

The turbomachine 1 may also comprise an inter-turbine casing 14. The inter-turbine casing 14 is arranged axially between the high-pressure turbine 6 and the low-pressure turbine 7.

The turbomachine 1 may also include an inter-duct compartment v3 located between the primary duct v1 and the secondary duct v2.

The fan shaft 10 is guided in rotation by a first bearing 15a and advantageously a second bearing 15b. The first and second bearings 15a are arranged radially between the fan shaft 10 and the inlet casing 13. Each first and second bearing 15a, 15b comprises, for example, a bearing arranged between an external ring and an internal ring. The external ring is supported by a first bearing support 16a extending radially inwards from the inlet casing 13. The internal ring is carried by the fan shaft 10. The rolling bearing is, for example, a row of balls. Advantageously, the rolling bearing comprises two rows of balls.

The low-pressure shaft 8 is guided in rotation by at least a third and fourth bearing 15c, 15d. The third bearing 15c is arranged radially between the inlet casing 13 and the low-pressure shaft 8. The third bearing 15c comprises a bearing, for example a row of balls, arranged radially between an internal ring and an external ring. The external ring is supported by a second bearing support 16b connected to the inlet casing 13. The internal ring is supported by the low-pressure shaft 8. The fourth bearing 15d is arranged radially between the inter-compressor casing 12 and the low-pressure shaft 8. The fourth bearing 15d comprises a bearing, for example a row of balls, arranged radially between an internal ring and an external ring. The external ring is supported by a third bearing support 16c connected to the inter-compressor casing 12. The internal ring is supported by the low-pressure shaft 8.

The high-pressure shaft 9 is guided in rotation by a fifth bearing 15e. The fifth bearing 15e, for example, is arranged radially between the high-pressure shaft 9 and the inter-turbine casing 14. The fifth bearing 15e comprises a bearing, for example a row of balls and a row of rollers arranged radially between an external ring and an internal ring. The internal ring is supported by the high-pressure shaft 9 and the external ring is supported by a fourth bearing support 16d connected to the inter-turbine casing 14.

The low-pressure shaft 8 can be guided in rotation downstream by a sixth bearing 15f arranged radially between a downstream end of the low-pressure shaft 8 and the inter-turbine casing 14, for example.

The bearings 15a, 15b, 15c, 15d, 15e, 15f and the speed reduction gear 11 must be lubricated with oil to ensure they function correctly. To prevent oil contamination of the associated members of turbomachine 1, the bearings 15a, 15b, 15c, 15d, 15e and the speed reduction gear 11 are arranged in lubrication enclosures.

To this end, the turbomachine 1 also comprises at least one lubrication enclosure, in particular a first upstream enclosure 17 in which the first, second and third bearings 15a, 15b, 15c and the speed reduction gear 11 are arranged, a second upstream lubrication enclosure 18 in which the fourth bearing 15d is arranged and a downstream lubrication enclosure 19 in which the fifth and sixth bearings 15e, 15f are arranged.

The upstream and downstream lubrication enclosures 17, 18 and 19 are annular. Each upstream and downstream lubrication enclosure 17, 18, 19 is bounded outwardly by a fixed part such as a casing and internally by a rotating part such as a shaft.

For example, the first upstream lubrication enclosure 17 is located in the internal shell of the inlet casing 13 and is bounded internally by the fan shaft 10. The second upstream lubrication enclosure 18 is located in the internal shell of the inter-compressor casing 12 and is bounded internally by the low-pressure shaft 8 and the downstream lubrication enclosure 18 is located in the internal shell of the inter-turbine casing 14 and is bounded internally by the high-pressure shaft 9.

The number of lubrication enclosures may vary depending on the configuration of the turbomachine 1. In the following, the upstream and downstream lubrication enclosures 17, 18 and 19 will be referred to interchangeably as “lubrication enclosures”.

With reference to FIG. 2, the lubrication enclosures 17, 18, 19 are supplied with oil by at least one oil circuit C. The oil circuit C of the turbomachine 1 is a closed circuit. The oil circuit C comprises an oil supply circuit C1 and an oil recovery circuit C2, which are connected to an oil tank 20 and lubrication enclosures 17, 18, 19.

In order to allow oil to circulate in the supply and recovery circuits C1, C2, the turbomachine 1 also comprises an assembly E comprising an accessory gearbox 21 and a lubrication unit comprising a supply pump 22 and a recovery pump 23 mounted on the accessory gearbox 21 and connected respectively to the supply and recovery circuits C1, C2.

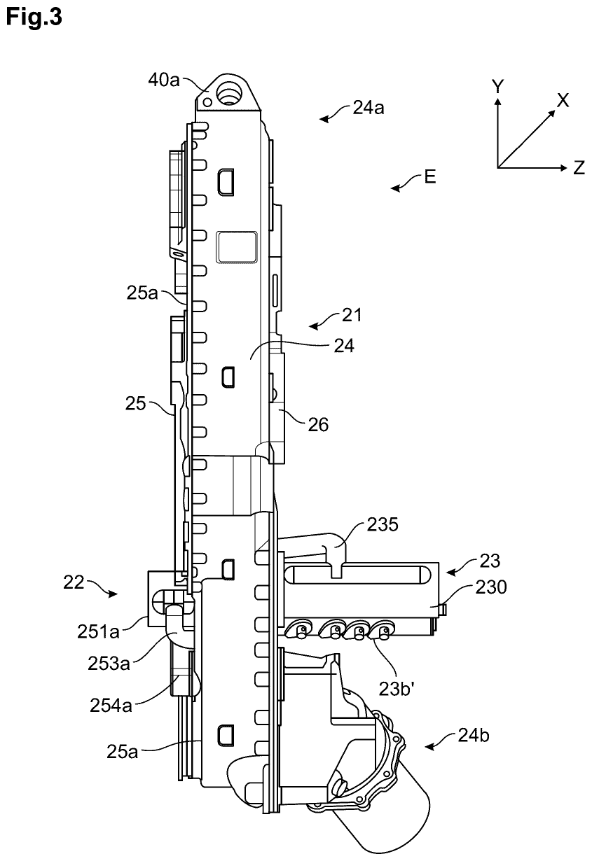

The accessory gearbox 21 (known simply as the gearbox) is housed in the inter-duct compartment v3, for example. With reference to FIG. 3, the gearbox 21 comprises a box 24. The box 24 extends substantially along a direction of elongation Y between a first end 24a and an opposite second end 24b. The box 24 comprises first and second walls 25, 26 and an internal cavity 27 bounded by the first and second walls 25, 26.

The first and second walls 25, 26 extend substantially in the direction of elongation Y. They are preferably curved. The first and second walls 25, 26 are, for example, integral or assembled together by fastening means such as screws and nuts. They each have an internal face facing the internal cavity 27 and an opposite external face.

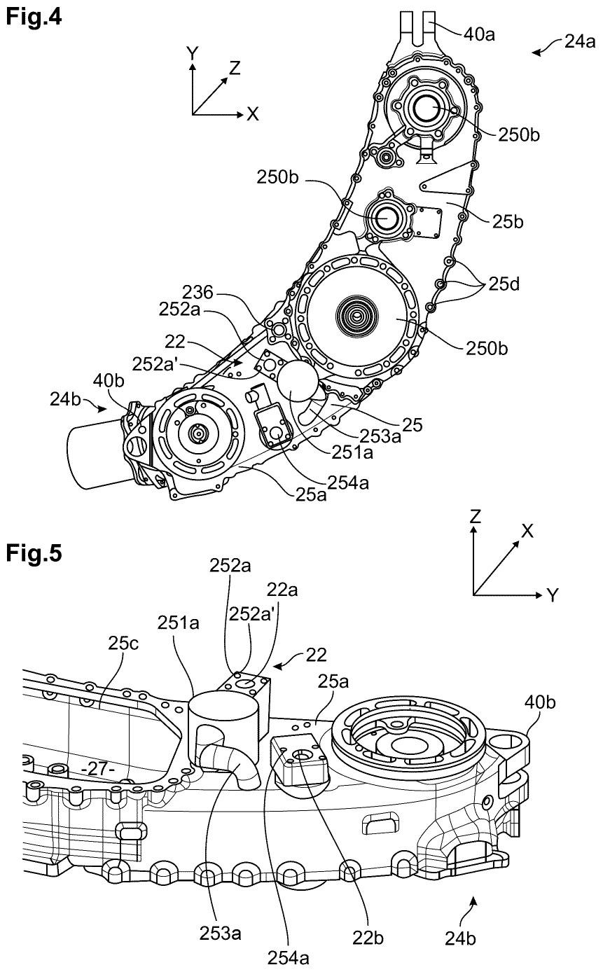

Referring to FIG. 4, the first wall 25 comprises a first structural part 25a and a first cover 25b.

With reference to FIGS. 4 and 5, the first structural part 25a is located, for example, on the side of the second end 24b of the box 24. It has a first window 25c passing through the external and internal faces of the first wall 25 and opening into the internal cavity 27. The first structural part 25a further comprises a cylindrical body 251a and a connecting block 252a which extend from the external face of the first wall 25. The connecting block 252a is carried by the cylindrical body 251a and has opposite lateral faces extending from the cylindrical body 251a and joined by a central face. The faces are flat. The connecting block 252a also comprises a transverse face 252a′ opposite the external face of the first wall 25. The transverse face 252a′ connects the lateral and central faces to each other. The cylindrical body 251a is hollow and comprises a cylindrical housing 251b. The cylindrical housing 251b opens into the internal cavity 27.

The first structural part 25a also comprises an oil filter associated with the supply pump 22 and arranged in a cylindrical receiving bowl 250a. The receiving bowl 250a extends inside the internal cavity 27 and opens onto the first structural part 25a.

The first structural part 25a also comprises an oil outlet pipe 253a connecting an outlet of the cylindrical body 251a to the receiving bowl 250a designed to contain the oil filter. In this way, the pipe 253a connects an outlet of the supply pump 22 to an inlet of the oil filter. The pipe 253a, for example, is bent.

The first cover 25b is located on the side of the first end 24a of the box 24. It covers the first window 25c. The first window 25c is therefore closed by the first cover 25b. The first cover 25b is removable. It is mounted and secured to the first structural part 25c by removable securing means such as an assembly of screws and nuts 25d. The first cover 25b has brackets 250b for securing accessories or equipment.

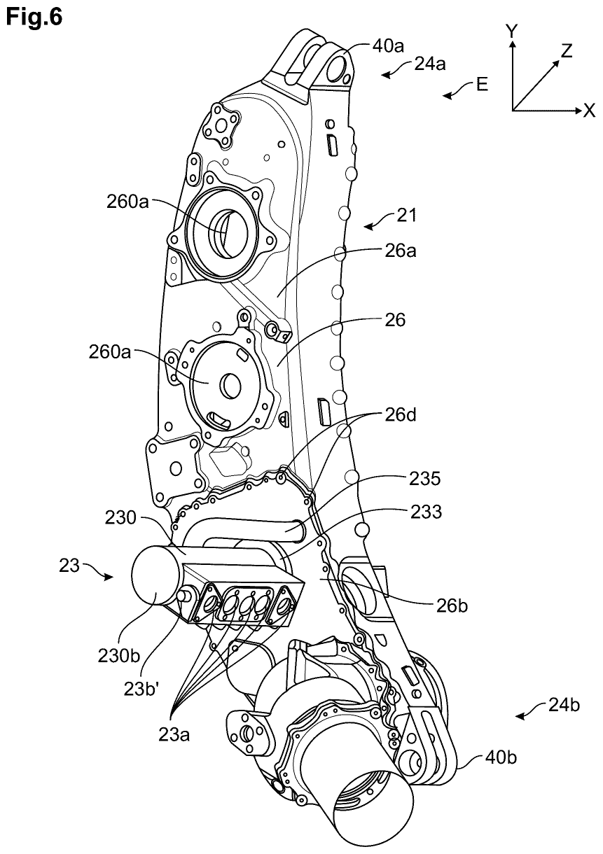

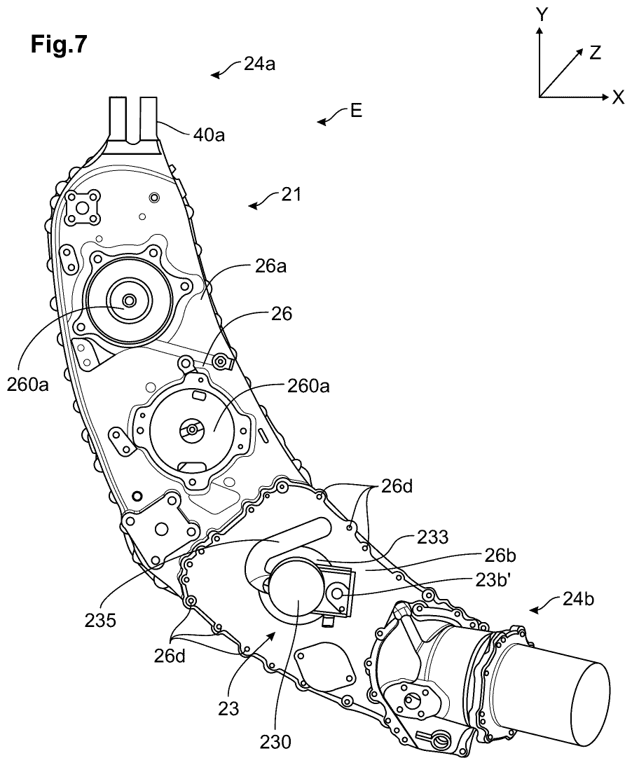

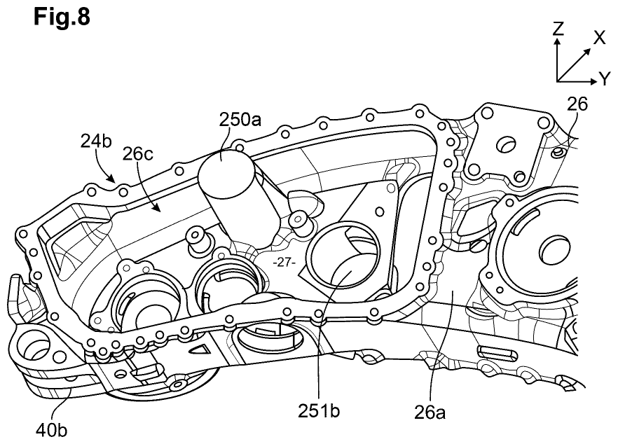

With reference to FIGS. 6, 7 and 8, the second wall 26 comprises a second structural part 26a and a second cover 26b.

The second structural part 26a is located on the side of the first end 24a of the box 24. It has a second window 26c passing through the external and internal faces of the second wall 26 and opening into the internal cavity 27. The second structural part 26a also includes brackets 260a for securing accessories or equipment.

The second cover 26b is located on the side of the second end 24b of the box 24. It covers the second window 26c. The second window 26c is therefore closed by the second cover 26b. The second cover 26b is removable. It is mounted and secured to the second structural part 26a by removable securing means such as a set of screws and nuts 26d.

The first and second covers 25b facilitate the installation and maintenance of the assembly E.

The first and second structural parts 25a, 26a form a monolithic part, for example.

The box 24 is made, for example, by additive manufacturing or lost wax casting.

The first and/or second walls 25, 26 may also include at least one valve seat. The first and/or second walls 25, 26 comprise, in particular, a bypass valve 41a and/or a flap valve 41b of the pressure relief valve (PRV) type, sensors or any other equipment required for operating the supply pump 22.

The internal cavity 27 extends in the direction of elongation Y. It is bounded by the first and second walls 25, 26.

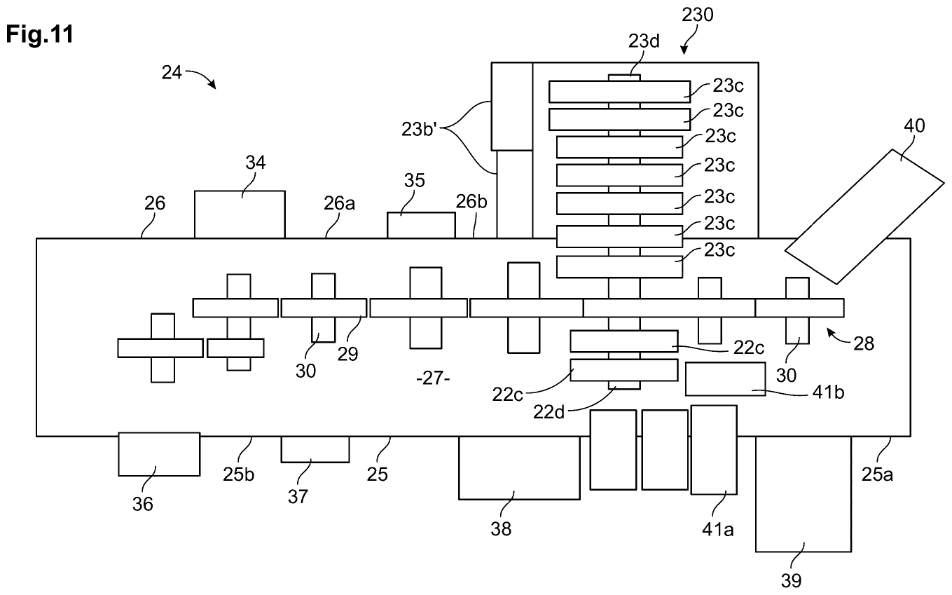

With reference to FIG. 11, the gearbox 21 further comprises a gear train 28 arranged in the internal cavity 27. The gear train 28 comprises a series of toothed wheels 29 each mounted coaxially around a respective shaft 30. The toothed wheels 29 mesh together. The drive of the toothed wheels 29 of the gear train 28 is achieved by drawing mechanical power from the low-pressure or high-pressure shaft 8, 9, for example. The mechanical power taken is transferred to the gear train 28 via a drive shaft 40 coupled to one of the shafts 30.

The gear train 28 is also coupled to the rotors of accessories or equipment. The accessories, also known as equipment, include, for example, a main fuel pump 34 (MFP) and/or a permanent magnet alternator 35 (PMA) and/or an engine drive pump 36 (EDP) and/or an accessory hand crank pad (HCP) and/or an integrated drive generator 38 (IDG) and/or an air turbine starter (ATS).

The gearbox 21 also comprises at least one clevis for suspension from a fixed structure of the turbomachine 1. A first clevis 40a, for example, is connected to one of the first and/or second ends 24a, 24b of the box 24. Preferably, the gearbox 21 comprises a first clevis 40a connected to the first end 24a of the box 24 and a second clevis 40b connected to the second end 24b of the box 24. Each clevis 40a, 40b preferably comprises two ears, each with a bore for a pin to pass through. The clevises 40a, 40b allow the gearbox 21 to be secured in the turbomachine 1, for example to a casing in the inter-duct compartment v3.

The supply pump 22 enables oil to be sucked from the tank 20 and circulated in the supply circuit C1.

With reference to FIGS. 3, 4 and 5, the supply pump 22 comprises an oil inlet 22a connected to the tank 20 and an oil outlet 22b connected to the lubrication enclosure 17, 18, 19. According to a particularly advantageous mode of the invention, the oil inlets and outlets 22a, 22b are provided on the first wall 25, in particular on the first structural part 25a of the first wall 25. As can be seen more clearly in FIG. 5, the oil inlet 22a is formed, for example, in the connection block 252a and the oil outlet 22b is formed in a support 254a shaped to be connected to an outlet pipe forming part of the supply circuit C1. As the oil filter is located downstream of the supply pump 22 according to the oil flow in the supply circuit C1, the pipe 253a connects an oil outlet of the cylindrical body 251a to an inlet of the oil filter associated with the supply pump 22.

The oil inlets and outlets 22a, 22b of the supply pump 22 are therefore formed directly on the first wall 25 of the gearbox 21. This characteristic allows the use of a dedicated casing for the supply pump 22, thereby reducing the overall dimensions. The overall dimensions and mass of the assembly E are therefore greatly reduced. The number of interfaces between the gearbox 21 and the lubrication unit is also reduced, thereby improving the reliability of the assembly E.

The supply pump 22 also comprises at least one rotor 22c. Advantageously, the supply pump 22 comprises two rotors 22c. The presence of two rotors 22c allows to reduce the diameter of the supply pump 22 and improve the reliability of the supply pump 22 while providing a more stable output compared with a supply pump which would have a single rotor with a similar flow rate.

According to the invention, the rotor(s) 22c of the supply pump 22 are arranged in the internal cavity 27 of the gearbox 21. In particular, the rotors 22c are located in the cylindrical housing 251b.

This characteristic allows the use of a dedicated casing for the supply pump 22, thereby reducing the overall dimensions. The overall dimensions and mass of the assembly E are therefore greatly reduced. This characteristic of the invention allows to reduce the volume of the assembly E.

The supply pump 22 also comprises a first drive shaft 22d of the rotors 22c. The rotors 22c are mounted coaxially around the first drive shaft 22d. It is thus understood that the first drive shaft 22d is also located in the internal cavity 27. The first drive shaft 22d is coupled to the gear train 28. The first drive shaft 22d is coupled to a toothed wheel 29 of the gear train 28 to drive it in rotation.

The recovery pump 23 allows the oil to be sucked out of the lubrication enclosures 17, 18, 19 and the circulation of the sucked oil into the recovery circuit C2.

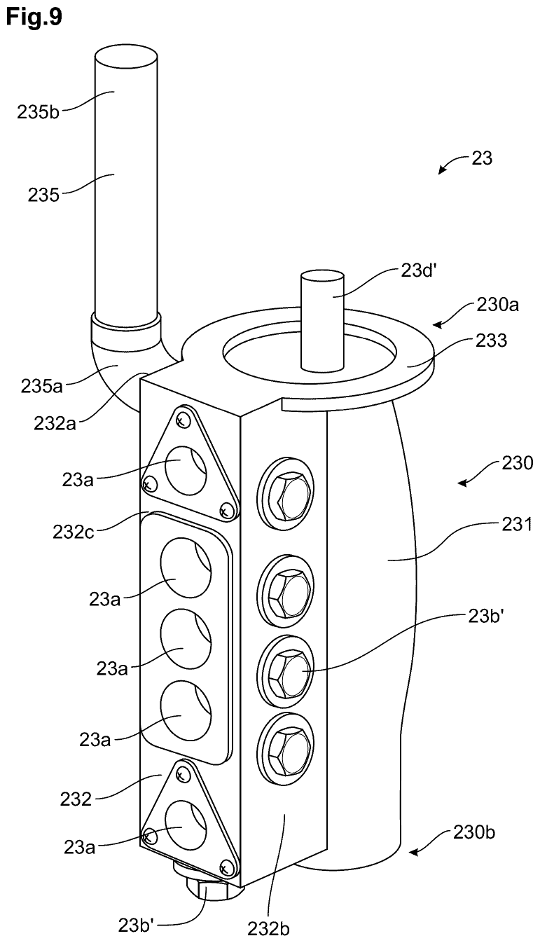

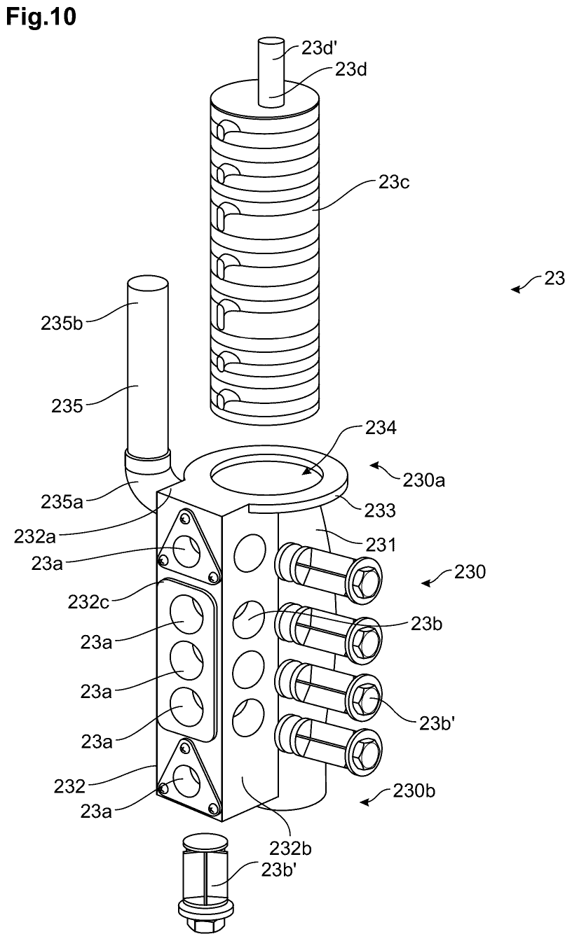

With reference to FIGS. 9 and 10, the recovery pump 23 advantageously comprises a casing 230 mounted and secured to the second wall 26 of the gearbox 21. Preferably, the casing 230 is secured to the second cover 26b of the second wall 26.

The casing 230 has a generally tubular shape extending between first and second ends 230a, 230b. The first end 230a is open and the second end 230b is closed. The casing 230 comprises a cylindrical body 231 and a connecting block 232 extending between the first and second ends 230a, 230b. The connecting block 232 is carried by the cylindrical body 231 and has opposite lateral faces 232a, 232b extending from the cylindrical body 231 and joined by a central face 232c. The faces 232a, 232b and 232c are flat. The casing 230 also comprises a flange 233 for securing to the second wall 26 located on the first end 230a of the cylindrical body 231 and a tubular internal housing 234 extending into the cylindrical body 231.

The recovery pump 23 also comprises at least one oil inlet 23a connected to the lubrication enclosures 17, 18, 19. Advantageously, the recovery pump 23 comprises a plurality of oil inlets 23a, for example between two and ten oil inlets 23a, each oil inlet 23a being respectively connected to a lubrication enclosure 17, 18, 19. The oil inlets 23a are provided in the casing 230, advantageously in the connecting block 232, and in particular on the central face 232c of the connecting block 232.

The recovery pump 23 also comprises at least one housing 23b for receiving a strainer 23b′. Advantageously, the recovery pump 23 comprises as many housings 23b as there are oil inlets 23a. The housings 23b are formed in the connecting block 232, in particular on the second lateral face 232b of the connecting block 232 and/or on a face of the connecting block 232 opposite the end flange 233. Each housing 23b has a circular cross-section and communicates with a respective oil inlet 23a. The strainers 23b′ are respectively arranged in a corresponding housing 23b.

The recovery pump 23 also comprises an oil outlet pipe 235 fluidly connected to an oil outlet orifice 236 connected to the tank 20.

The pipe 235 is secured to the casing 230. It is connected to the cylindrical body 231. The pipe 235 is angled. It comprises a first portion 235a connected to the cylindrical body 231 opposite the second end 232b and a second portion 235b forming a right angle with the first portion 231. The second portion 235b is fluidly connected to the orifice 236. According to a first embodiment, the pipe 235 extends into the internal cavity 27 and passes through the second wall 26. According to this first example, the pipe 235 opens into the orifice 236. According to another example, the gearbox 21 further comprises an oil circulation passage in the internal cavity 27 which connects the pipe 235 to the orifice 236.

The orifice 236 is formed in the first wall 25. For example, it is formed in the first cover 25b of the first wall 25.

The recovery pump 23 also comprises at least one rotor 23c. Advantageously, the recovery pump 23 comprises a plurality of rotors 23c. Preferably, the recovery pump 23 comprises as many rotors 23c as there are oil inlets 23a. The rotors 23c are arranged in the internal housing 234 of the casing 230.

According to the invention, the rotors 22c, 23c of the supply and recovery pumps 22, 23 are arranged on either side of the gear train 28. This characteristic of the invention balances the load on the gear train.

The recovery pump 23 also comprises a second drive shaft 23d for the rotors 23c. The rotors 23c are mounted around the second drive shaft 23d which extends into the internal housing 234 of the casing 230. The second drive shaft 23d comprises an end portion 23d′ which extends outside the internal housing 234. The second drive shaft 23d is coupled to the gear train 28. For example, the end portion 23d′ has splines for coupling to a shaft 30 of a gear wheel 29 of the gear train 28. Preferably, the second drive shaft 23d is coupled to the same toothed wheel 29 to which the first drive shaft 22d of the supply pump 22 is coupled.

Preferably, the first and second drive shafts 22d, 23d extend respectively on either side of the gear train 28.

1. An assembly for an aircraft turbomachine the assembly comprising:
an accessory gearbox comprising:
first and second walls defining between them an internal cavity, and
a gear train arranged in the internal cavity, intended to be driven by a shaft of the turbomachine, and
a lubrication unit comprising an oil supply pump and an oil recovery pump, the supply and recovery pumps each comprising at least one rotor driven by the gear train,
the assembly being characterized in that the rotors of the supply and recovery pumps are arranged on either side of the gear train, and in that the rotor of the supply pump is arranged in the internal cavity.

2. The assembly according to claim 1, wherein the supply pump comprises an oil inlet and an oil outlet provided on the first wall.

3. The assembly according to claim 2, wherein the first wall comprises a cylindrical body extending in a projecting manner and having a cylindrical housing opening into the internal cavity and fluidically connected to the oil inlet and outlet, the rotor of the supply pump being arranged in the cylindrical housing.

4. The assembly according to claim 1, wherein the first wall further comprises a receiving bowl of an oil filter, the receiving bowl extending into the internal cavity and being connected to the cylindrical body by an oil outlet pipe.

5. The assembly according to claim 1, wherein the recovery pump comprises a casing comprising at least one oil inlet and an internal housing wherein the rotor of the recovery pump is arranged, the casing being mounted and secured to the second wall.

6. The assembly according to claim 5, wherein the casing comprises at least one oil outlet pipe fluidically connected to an oil outlet orifice of the recovery pump, the orifice being formed on the first wall.

7. The assembly according to claim 6, wherein the gearbox further comprises an oil circulation passage in the internal cavity connecting the pipe to the orifice.

8. The assembly according to claim 1, wherein the supply pump comprises two rotors driven by the gear train and/or in that the recovery pump comprises at least two rotors driven by the gear train.

9. The assembly according to claim 1, wherein the rotor or the rotors of the supply pump are driven by a first drive shaft which is coupled to the gear train, and the rotor or the rotors of the recovery pump are driven by a second drive shaft which is coupled to the gear train, the first and second shafts extending respectively on either side of the gear train.

10. The assembly according to claim 9, wherein the gear train comprises a series of toothed wheels meshing together, and the first and second drive shafts are coupled in rotation to a single toothed wheel of the gear train.

11. The assembly according to claim 1, wherein the first wall and/or the second wall comprises at least one valve.

12. A turbomachine for an aircraft, comprising:
a fan configured to drive an air flow separating into a primary air flow and a secondary air flow,
a primary duct for the flow of the primary air flow,
a secondary duct for the flow of the secondary air flow,
an inter-duct compartment separating the primary duct and the secondary duct wherein said turbomachine further comprises an assembly according to claim 1 located in the inter-duct compartment.
